(19) United States
(12) Patent Application Publication
(10) Pub. No.: US 2013/0050871 A1
(43) Pub. Date: Feb. 28, 2013

(54) SPINDLE MOTOR AND DISK DRIVE APPARATUS

(71) Applicant: Takehito TAMAOKA, Kyoto (JP)

(72) Inventor: Takehito TAMAOKA, Kyoto (JP)

(73) Assignee: NIDEC CORPORATION, Kyoto (JP)

(21) Appl. No.: 13/562,344

(22) Filed: Jul. 31, 2012

(30) Foreign Application Priority Data
Aug. 23, 2011 (JP) 2011-181419

(51) Int. Cl. H02K 21/16; G11B 17/02

(52) U.S. Cl. 360/99.08; 310/156.01; G9B/17.002

(57) ABSTRACT

A spindle motor includes a stationary portion, and a rotating portion supported rotatably with respect to the stationary portion. The stationary portion includes a base portion, a ring-shaped core back, a plurality of teeth, and a coil. The rotating portion includes a magnet radially opposite to a radially inner end surface of the teeth and a hub arranged to hold the magnet. The teeth include an outer core portion arranged radially outward from an outer circumference of the hub, and an inner core portion arranged radially inward from the outer core portion. The inner core portion includes a positioning portion which is positioned radially outward from the outer circumference of the hub, and arranged radially inward from the coil, and the width of the positioning portion in a circumferential direction is larger than the width of the outer core portion in the circumferential direction.

### BACKGROUND OF THE INVENTION

1. Field of the Invention

The present invention relates to a spindle motor and a more specifically to a spindle motor preferably for use in a disk drive apparatus, for example.

2. Description of the Related Art

A hard disk device is typically provided with a spindle motor for rotating a disk. Conventional spindle motors are, for example, described in Japanese Laid-Open Patent Publication No. 2006-230095 and Japanese Laid-Open Patent Publication No. 2008-187844. The spindle motors described in these patent publications are both so-called inner rotor type spindle motors. In the inner rotor type spindle motor, a magnet is rotated on the inside of a coil. The inner rotor type spindle motor is often used in a hard disk device which is desired to be thinner.

In the configuration described in Japanese Laid-Open Patent Publication No. 2006-230095 and Japanese Laid-Open Patent Publication No. 2008-187844, an inner circumferential portion of the coil is arranged below an outer circumferential portion of a rotor hub. Therefore, in the dimensioning of a spindle motor, the thickness of the coil in an axial direction and the thickness of the outer circumferential portion of the rotor hub in the axial direction are simply added. For this reason, with such configurations, it is difficult to further reduce the thickness of the spindle motor.

As a configuration for further reducing the thickness of a spindle motor, it is suggested that the whole of the coil be arranged on a radially outer side of the outer circumference of the rotor hub for example. With such a configuration, the outer circumferential portion of the rotor hub can be arranged closer to teeth in the axial direction. However, in the case where the outer circumferential portion of the rotor hub is arranged closer to the teeth in the axial direction, there is some fear that a conducting wire defining the coil may come into contact with the outer circumference of the rotor hub because of the collapse of the coil.

### SUMMARY OF THE INVENTION

In one preferred embodiment of the present invention, a spindle motor includes a stationary portion and a rotating portion. The rotating portion is rotatably supported with respect to the stationary portion while being centered on a center axis extending vertically. The stationary portion preferably includes a base portion, a ring-shaped core back, a plurality of teeth, and a coil. The base portion extends in a direction orthogonal or substantially orthogonal to the center axis extending vertically. The ring-shaped core back is preferably arranged on the side of an upper surface of the base portion. The plurality of teeth protrudes radially inwards from the core back. The coil is attached to the teeth. The rotating portion preferably includes a magnet and a hub. The magnet is radially opposite to a radially inner end surface of the teeth. The hub is arranged to hold the magnet. The teeth preferably include an outer core portion and an inner core portion. The outer core portion is arranged radially outward from an outer circumference of the hub. On the outer core portion, a conducting wire defining the coil is wound. The inner core portion is arranged radially inward from the outer core portion. The inner core portion preferably includes a positioning portion. The positioning portion is arranged radially outward from the outer circumference of the hub, and arranged radially inward from the coil. In the spindle motor, the width of the positioning portion in a circumferential direction is preferably larger than the width of the outer core portion in the circumferential direction.

A disk drive apparatus preferably includes the above-described spindle motor, an access unit, and a cover. The access unit performs at least one of reading and writing of information from and to a disk supported by the rotating portion of the spindle motor. A housing preferably includes the base portion and the cover. The rotating portion and the access unit are accommodated in the interior of the housing.

In one preferred embodiment of the present invention, the contact of the conducting wire defining the coil with the outer circumference of the hub can be prevented. In addition, the disk drive apparatus includes the above-described spindle motor, so that the thickness of the disk drive apparatus can be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a longitudinal sectional view of a spindle motor according to a preferred embodiment of the present invention.

FIG. 2 is a partial top view of a stationary portion according to a preferred embodiment of the present invention.

FIG. 3 is a longitudinal sectional view of a disk drive apparatus according to a preferred embodiment of the present invention.

FIG. 4 is a longitudinal sectional view of a spindle motor according to a preferred embodiment of the present invention.

FIG. 5 is a partial longitudinal sectional view of the spindle motor according to a preferred embodiment of the present invention.

FIG. 6 is a top view of a stator core according to a preferred embodiment of the present invention.

FIG. 7 is a partial top view of the stator core according to a preferred embodiment of the present invention.

FIG. 8 is a partial top view of the stator core according to a preferred embodiment of the present invention.

FIG. 9 is a partial top view of the stator core according to a preferred embodiment of the present invention.

FIG. 10 is a partial top view of the stator core according to a preferred embodiment of the present invention.

FIG. 11 is a partial top view of the stator core according to a preferred embodiment of the present invention.

### DETAILED DESCRIPTION OF THE PREFERRED EMBODIMENTS

Referring to the attached drawings, preferred embodiments of the present invention will be described in detail. Meanwhile, in the following description, a direction along the center axis indicates a vertical direction, i.e. up/down directions and the side of the coil with respect to the base portion is the upper side. The definition of the up/down directions is only for convenience of explanation, and the positional relationships and orientations in the use of the spindle motor and the disk drive apparatus according to preferred embodiments of the present invention are not limited by the definition.

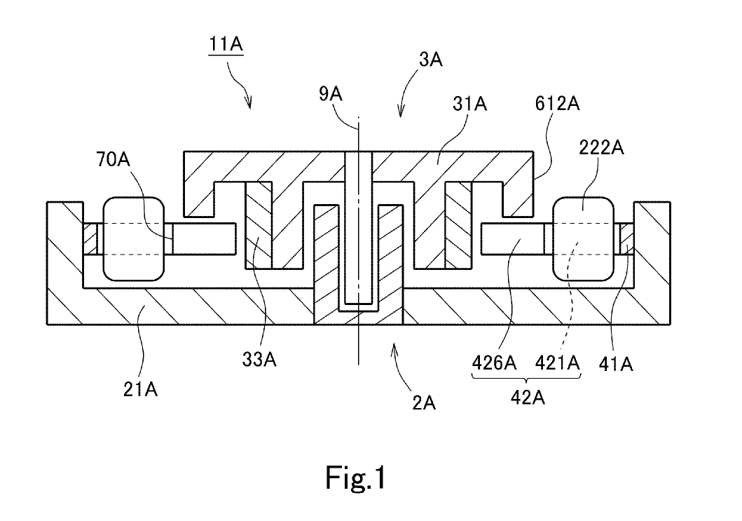

FIG. 1 is a longitudinal sectional view of a spindle motor 11A in one preferred embodiment of the present invention. As shown in FIG. 1, the spindle motor 11A includes a stationary portion 2A and a rotating portion 3A. The rotating portion 3A is rotatably supported with respect to the stationary portion 2A.

The stationary portion 2A preferably includes a base portion 21A, a ring-shaped core back 41A, a plurality of teeth 42A, and a coil 222A. The base portion 21A preferably extends in a direction orthogonal or substantially orthogonal to a center axis 9A. The core back 41A is preferably located on the top side of the base portion 21A. The teeth 42A preferably protrude radially inwards from the core back 41A. The coil 222A is attached to the teeth 42A.

The rotating portion 3A rotates around the center axis 9A. The rotating portion 3A preferably includes a hub 31A and a magnet 33A. The magnet 33A is held by the hub 31A. The magnet 33A is radially opposed to a radially inner end surface of the teeth 42A.

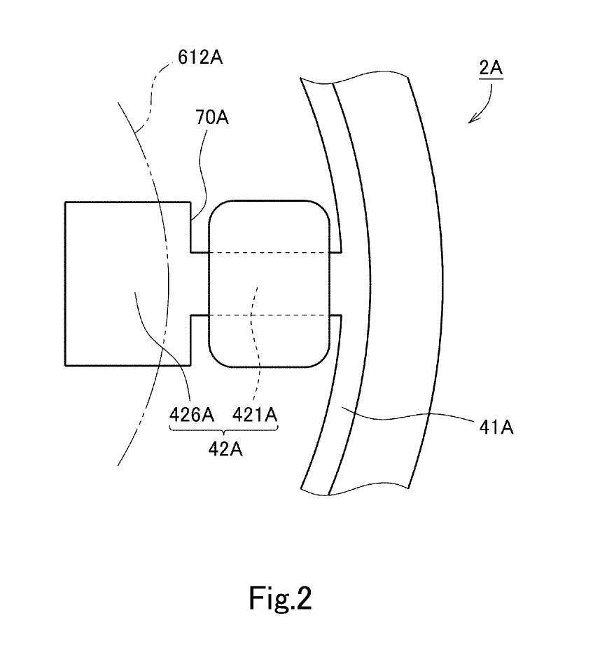

FIG. 2 is a partial top view of the stationary portion 2A in the vicinity of one of the teeth 42A. In FIG. 2, an outer circumference 612A of the hub 31A is depicted by two-dot chain line. As shown in FIG. 1 and FIG. 2, the teeth 42A preferably include an outer core portion 421A and an inner core portion 426A. The outer core portion 421A is located radially outer from the outer circumference 612A of the hub 31A. A conducting wire defining the coil 222A is wound around the outer core portion 421A.

The inner core portion 426A is located radially inward from the outer core portion 421A. The inner core portion 426A preferably includes a positioning portion 70A. The positioning portion 70A is located radially outward than the outer circumference 612A of the hub 31A and radially inward from the coil 222A. Since the width in the circumferential direction (hereinafter referred to as the circumferential width) of the positioning portion 70A is preferably larger than the circumferential width of the outer core portion 421A, the collapse of the coil 222A is prevented by the positioning portion 70A. As a result, contact between the conducting wire defining the coil 222A and the outer circumference 612A of the hub 31A is reliably prevented.

Next, more specific preferred embodiments of the present invention will be described.

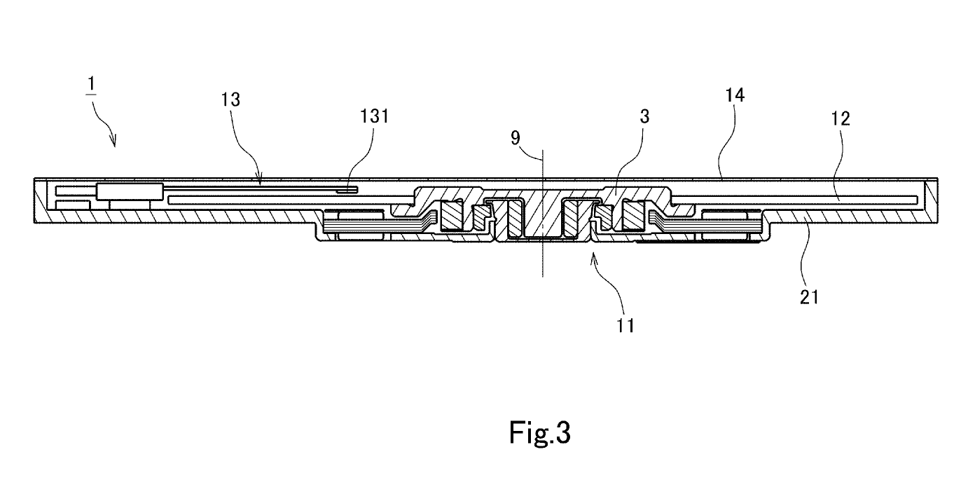

FIG. 3 is a longitudinal sectional view of a disk drive apparatus 1. The disk drive apparatus 1 is a device arranged to rotate a magnetic disk 12 and to perform at least one of “reading” and “writing” of information from and into the magnetic disk 12. As shown in FIG. 3, the disk drive apparatus 1 preferably includes a spindle motor 11, a magnetic disk 12, an access unit 13, and a cover 14.

The spindle motor 11 holds the magnetic disk 12 and rotates the magnetic disk 12 around the center axis 9. The spindle motor 11 preferably includes a base portion 21 extending along the lower surface of the magnetic disk 12. A housing preferably includes the base portion 21 and the cover 14. The rotating portion 3 of the spindle motor 11, the magnetic disk 12, and the access unit 13 are preferably accommodated in the interior of the housing.

The access unit 13 moves ahead 131 along a recording surface of the magnetic disk 12. By using the head 131, the access unit 13 performs “the reading” and “the writing” of information to and from the magnetic disk 12. The access unit 13 may have two or more heads 131. Alternatively, the access unit 13 may perform only either one of “the reading” or “the writing” of information to or from the magnetic disk 12.

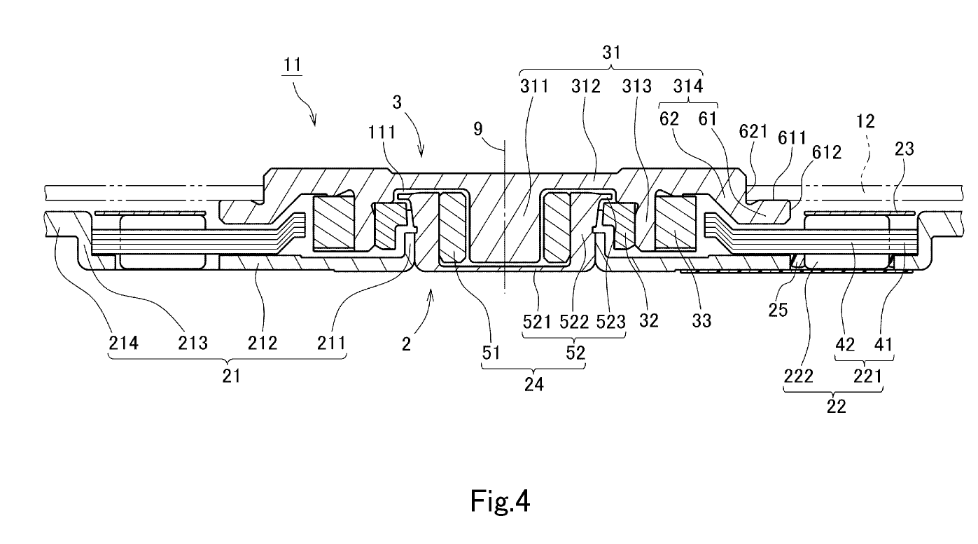

Next, the configuration of the spindle motor 11 will be described. FIG. 4 is a longitudinal sectional view of the spindle motor 11. As shown in FIG. 4, the spindle motor 11 has a stationary portion 2 and a rotating portion 3. The stationary portion 2 is preferably fixed or relatively fixed with respect to the base portion 21 and the cover 14. The rotating portion 3 is rotatably supported with respect to the stationary portion 2.

The stationary portion 2 in the present preferred embodiment preferably includes a base portion 21, a stator unit 22, a magnetic shielding plate 23, and a stationary bearing unit 24.

The base portion 21 supports the stator unit 22 and the stationary bearing unit 24. The base portion 21 is preferably formed, for example, by press-processing a plate of a magnetic material (or example, a galvanized steel plate, or the like). As shown in FIG. 4, the base portion 21 preferably includes an inner cylindrical portion 211, an inner flat-plate portion 212, an outer cylindrical portion 213, and an outer flat-plate portion 214.

The inner cylindrical portion 211 is preferably arranged coaxially or substantially coaxially with the center axis 9. The inner flat-plate portion 212 preferably extends radially outwards from a lower end portion of the inner cylindrical portion 211. Herein the radial direction is a direction orthogonal to the center axis or a direction substantially orthogonal to the center axis. The definition will be used in the same way in the following description. The outer cylindrical portion 213 extends upwards from an outer circumferential portion of the inner flat-plate portion 212. The outer flat-plate portion 214 extends further outwards in the radial direction from an upper end portion of the outer cylindrical portion 213.

The stator unit 22 preferably includes a stator core 221 and a plurality of coils 222. The stator core 221 is located on an upper side of the inner flat-plate portion 212 and on the radially inside of the outer cylindrical portion 213. The stator core 221 is preferably defined by a laminated steel plate member, which is preferably constructed by laminating a plurality of magnetic steel plates in an axial direction. The axial direction is a direction parallel to the center axis or a direction substantially parallel to the center axis. The definition will be used in the same way in the following description. As the magnetic steel plates, for example, a silicon steel plate or the like may preferably be used. The stator core 221 preferably includes a ring-shaped core back 41, and a plurality of teeth 42 protruding radially inwards from the core back 41.

The core back 41 is preferably, for example, press fitted into an inner circumference of the outer cylindrical portion 213 of the base portion 21. Alternatively, the core back 41 is, for example, bonded to the inner circumference of the outer cylindrical portion 213 of the base portion 21 via a gap. The plurality of teeth 42 are preferably arranged at equal or substantially equal intervals in a circumferential direction. The core back 41 and the coils 222 are preferably arranged radially outward from an outer circumference 612 of a hub 31 which will be described later. On the other hand, a radially inner end portion of the teeth 42 is arranged radially inward from the outer circumference 612 of the hub 31.

The coils 222 are preferably attached in the vicinity of a radially outer end portion of the teeth 42. An end portion of a conducting wire defining the coil 222 is preferably connected to a power supplying device via, for example, a circuit board (not shown).

The magnetic shielding plate 23 is preferably a ring-shaped member, and is made of a magnetic material. The magnetic shielding plate 23 is preferably located between an upper end portion of the coil 222 and a lower surface of the magnetic disk 12. In this preferred embodiment, magnetic interaction between the coil 22 and the magnetic disk 12 is reduced by the magnetic shielding plate 23. With such a configuration, the distance between the coil 222 and the magnetic disk 12 in the axial direction is shortened.

The stationary bearing unit 24 is a mechanism arranged to rotatably support the hub 31 on the side of the rotating portion 3. The stationary bearing unit 24 preferably includes a substantially cylindrical sleeve 51 and a sleeve housing 52. The sleeve housing 52 has a substantially cylindrical shape with a bottom and holds the sleeve 51. The sleeve 51 surrounds an outer circumference of a shaft portion 311 which will be described later. Lubricating oil 111 is preferably interposed between the hub 31 which will be described later, and the sleeve 51 and the sleeve housing 52.

The sleeve housing 52 preferably includes a bottom portion 521, a cylindrical portion 522, and a flange portion 523. An upper surface of the bottom portion 521 axially faces a lower end portion of the shaft portion 311. The cylindrical portion 522 preferably extends upwards from an outer circumferential portion of the bottom portion 521. The cylindrical portion 522 is preferably, for example, press fitted into an inner circumference of the inner cylindrical portion 211 of the base portion 21, or bonded thereto via a gap. The flange portion 523 protrudes radially outwards from an upper end portion of the cylindrical portion 522.

The rotating portion 3 in the present preferred embodiment preferably includes the hub 31, a retaining member 32, and a magnet 33.

The hub 31 rotates around the center axis 9 while being supported by the stationary bearing unit 24. The hub 31 is preferably made of, for example, a ferromagnetic material such as ferritic stainless steel. The hub 31 preferably includes a shaft portion 311, a top plate portion 312, an annular holding portion 313, and a disk supporting portion 314. The shaft portion 311 extends in a substantially cylindrical manner along the center axis 9. The shaft portion 311 is inserted into the inside of the sleeve 51. The top plate portion 312 extends towards the radially outer side from an upper end portion of the shaft portion 311. The annular holding portion 313 preferably extends downwards in a cylindrical or a substantially cylindrical manner from a lower surface of the top plate portion 312.

The disk supporting portion 314 is arranged radially outward from the magnet 33. The disk supporting portion 314 preferably includes an annular surface portion 61 and an annular wall portion 62. The annular wall portion 62 extends downwards from an outer circumferential portion of the top plate portion 312. The annular surface portion 61 protrudes radially outwards from a lower end portion of the annular wall portion 62. A top surface of the annular surface portion 61 preferably includes a first supporting surface 611 which is in contact with a lower surface of the magnetic disk 12. The position of the magnetic disk 12 in the axial direction is determined by the first supporting surface 611. An outer circumference of the annular wall portion 62 preferably includes a second supporting surface 621 which is in contact with an inner circumferential portion of the magnetic disk 12. The position of the magnetic disk 12 in the radial direction is determined by the second supporting surface 621.

The retaining member 32 is a ring-shaped member. The retaining member 32 is preferably located radially inward from the annular holding portion 313, lower than the top plate portion 312, and radially outward from the stationary bearing unit 24. The retaining member 32 is preferably fixed to the inner circumference of the annular holding portion 313 by an adhesive, for example. An inner circumferential portion of the retaining member 32 is positioned below the flange portion 523 of the sleeve housing 52. If the rotating portion 3 is to move upwards, the lower surface of the flange portion 523 comes into contact with the upper surface of the inner circumferential portion of the retaining member 32. Accordingly, the upward movement of the rotating portion 3 is restricted.

The magnet 33 is a ring-shaped member. The magnet 33 is preferably located radially outward from the annular holding portion 313, lower than the top plate portion 312, and radially inward from the stator core 221. The magnet 33 is preferably fixed to the outer circumference of the annular holding portion 313 by an adhesive, for example. The outer circumference of the magnet 33 is radially opposite to radially inner end surfaces of the plurality of teeth 42, respectively. An N pole and an S pole are alternately magnetized in a circumferential direction on the outer circumference of the magnet 33.

In the spindle motor 11 with the above-described configuration, when a driving current is applied to the coil 222, a magnetic flux is radially generated in the plurality of teeth 42 of the stator core 221. Due to the action of the magnetic flux between the teeth 42 and the magnet 33, a torque is generated in the circumferential direction. As a result of the torque, the rotating portion 3 rotates around the center axis 9 with respect to the stationary portion 2. The magnetic disk 12 held by the hub 31 also rotates around the center axis 9 together with the rotating portion 3.

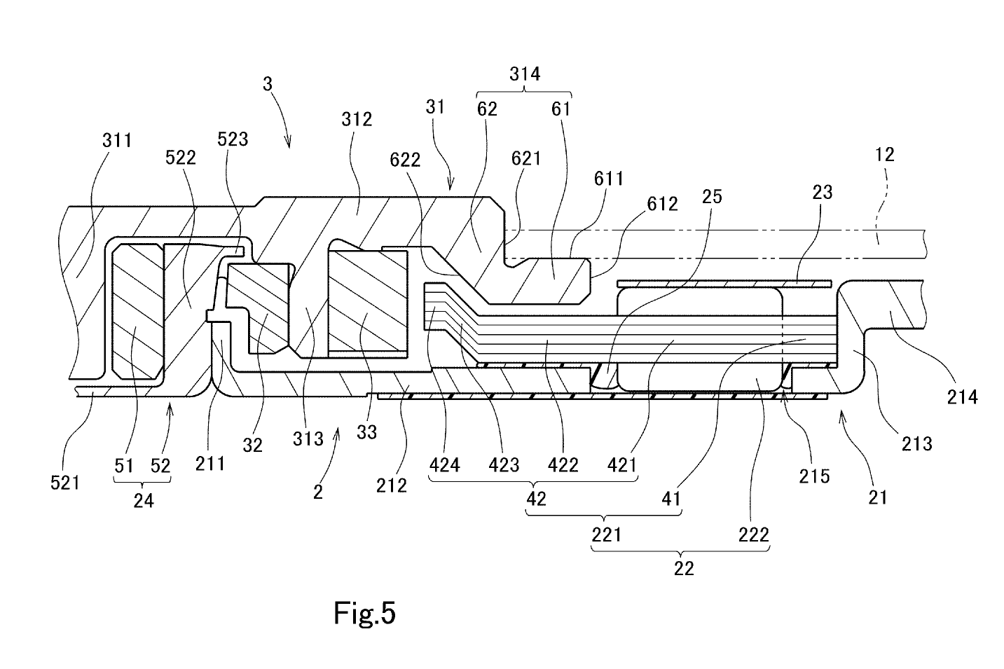

Next, more detailed configurations of the teeth 42 and in the vicinity of the teeth 42 will be described. FIG. 5 is a partial longitudinal sectional view of the spindle motor 11 of the present preferred embodiment. As shown in FIG. 5, each of the teeth 42 in the present preferred embodiment preferably includes an outer core portion 421, a middle core portion 422, and an inclined core portion 423, and an end core portion 424.

The outer core portion 421 is radially continuous with the middle core portion 422 in the same axial position. The outer core portion 421 is preferably positioned radially outward from the outer circumference 612 of the hub 31. A conducting wire which defines the coil 222 is wound around the outer core portion 421. The middle core portion 422 is positioned radially inward from the outer core portion 421 and the coil 222. The middle core portion 222 radially extends between the upper surface of the inner flat-plate portion 212 of the base portion 21 and the lower surface of the disk supporting portion 314 of the hub 31.

The inclined core portion 423 obliquely extends radially inwards and upwards from the inner circumferential portion of the middle core portion 422. The end core portion 424 extends radially inwards from the inner circumferential portion of the inclined core portion 423. Accordingly, at least the top end portion of the end core portion 424 is preferably located above the outer core portion 421 and the middle core portion 422. A radially inner end surface of the end core portion 424 is radially opposite to the outer circumference of the magnet 33. The whole of the end core portion 424 may alternatively be located above the outer core portion 421 and the middle core portion 422.

As shown in FIG. 5, the disk supporting potion 314 is positioned radially outward from the end core portion 424 of the teeth 42 and positioned radially inward from the coil 222. In addition, the end core portion 424, the annular surface portion 61, and the coil 222 preferably radially overlap. Specifically, at least a portion of the end core portion 424, at least portion of the annular surface portion 61, and at least a portion of the coil 222 are positioned at the same height, respectively.

Accordingly, the height position of the first supporting surface 611 with respect to the stator core 221 can be minimized as compared with the case where the annular surface portion is located above the coil or the end core portion. Accordingly, the height position of the first supporting surface 611 with respect to the base portion 21 is also significantly reduced. As a result, the axial dimension of the spindle motor 11 can be significantly reduced.

Especially, in the present preferred embodiment, the height position of the upper end portion of the coil 222 is preferably higher than the lower surface of the annular surface portion 61, but lower than the first supporting surface 611. Accordingly, the magnetic disk 12 will preferably not come into contact with the coil 222.

In the present preferred embodiment, the inner flat-plate portion 212 of the base portion 21 preferably includes a through hole 215. In addition, a lower portion of the coil 222 is accommodated in the interior of the through hole 215. Therefore, the lower end portion of the coil 222 is positioned below the upper surface of the inner flat-plate portion 212. In this way, the height position of the stator core 221 and the coil 222 with respect to the base portion 21 is significantly reduced. As a result, the axial dimension of the spindle motor 11 can be further reduced.

The end core portion 424 of the teeth 42 is preferably located above the outer core portion 421 and the middle core portion 422. Specifically, the upper end portion of the radially inner end surface of the end core portion 424 is preferably located at a higher position than the lower surface of the annular surface portion 61, and at a lower position than the first supporting surface 611. With such a configuration, the height position of the end core portion 424 is closer to the height position of the axial center of the magnet 33. Accordingly, a torque is efficiently generated between the end core portion 424 and the magnet 33.

In addition, in the present preferred embodiment, the inclined core portion 423 is preferably positioned radially inward from the second supporting surface 621 of the disk supporting portion 314. With such an arrangement, it is difficult for the annular surface portion 61 to restrict the axial position of the inclined core portion 423. Similarly, it is difficult for the inclined core portion 423 to restrict the axial position of the annular surface portion 61. Accordingly, the height of the annular surface portion 61 with respect to the stator core 221 can be even more significantly reduced. As a result, the axial dimension of the spindle motor 11 is even more significantly reduced.

It is preferred to provide a gap in the axial direction between the lower surface of the annular wall portion 62 of the disk supporting portion 314 and the upper surface of the inclined core portion 423. On the other hand, in order to increase the rigidity of the disk supporting portion 314, it is preferred that the thickness in the axial direction of the annular wall portion 62 be increased. In the present preferred embodiment, in order to satisfy both of the preferred features, the lower surface of the annular wall portion 62 functions as an inclined lower surface 622 extending along the upper surface of the inclined core portion 423. Accordingly, a minimum gap can be ensured between the inclined core portion 423 and the annular wall portion 62, and the thickness in the axial direction of the disk supporting portion 314 can be ensured.

In order to realize a thinner spindle motor 11, it is preferred that an axial gap between the upper surface of the middle core portion 422 and the lower surface of the annular surface portion 61 be at a minimum. For example, the axial gap between the upper surface of the middle core portion 422 and the lower surface of the annular surface portion 61 is preferably smaller than the radial gap between the radially inner end surface of the end core portion 424 and the outer circumference of the magnet 33.

In addition, in the present preferred embodiment, the whole of the magnetic shielding plate 23 is preferably located radially outward from the outer circumference 612 of the hub 31. Moreover, the upper surface of the magnetic shielding plate 23 is preferably positioned below the first supporting surface 611. The end core portion 424 and the annular surface portion 61 preferably radially overlap not only the coil 222 but also the magnetic shielding plate 23. Accordingly, an increase of the axial dimension caused by the magnetic shielding plate 23 can be significantly reduced and prevented.

In the present preferred embodiment, the upper end portion of the magnet 33 is preferably positioned above the first supporting surface 611. With such a configuration, the height of the first supporting surface 611 with respect to the base portion 21 can be significantly reduced, and the axial dimension of the magnet 33 can be increased. If the axial dimension of the magnet 33 can be increased, the magnetic force of the magnet 33 is increased and the torque of the spindle motor 11 is enhanced.

In the case of a configuration in which the teeth extend radially inwards like a thin plate from the core back, the teeth 42 may disadvantageously vibrate vertically. In the present preferred embodiment, an adhesive 25 is preferably provided between the upper surface of the inner flat plate portion 212 and the lower surface of the middle core portion 422. With such a provision, the vibration of the teeth 42 can be significantly reduced and prevented as compared with the case where the adhesive is not provided.

In the present preferred embodiment, the annular holding portion 313 holds the retaining member 32 and the magnet 33. With such a configuration, the rigidity of the annular holding portion 313 is enhanced as compared with the case where any other portion of the hub 31 holds the magnet 33. Accordingly, the strength against the external force (vibrations, shocks, or the like) is further increased.

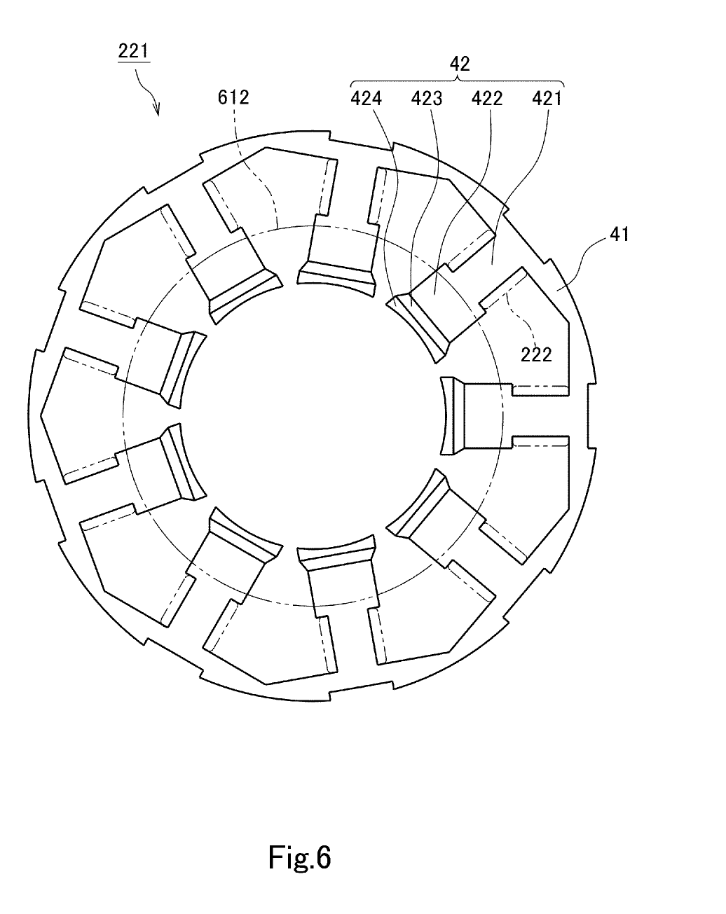

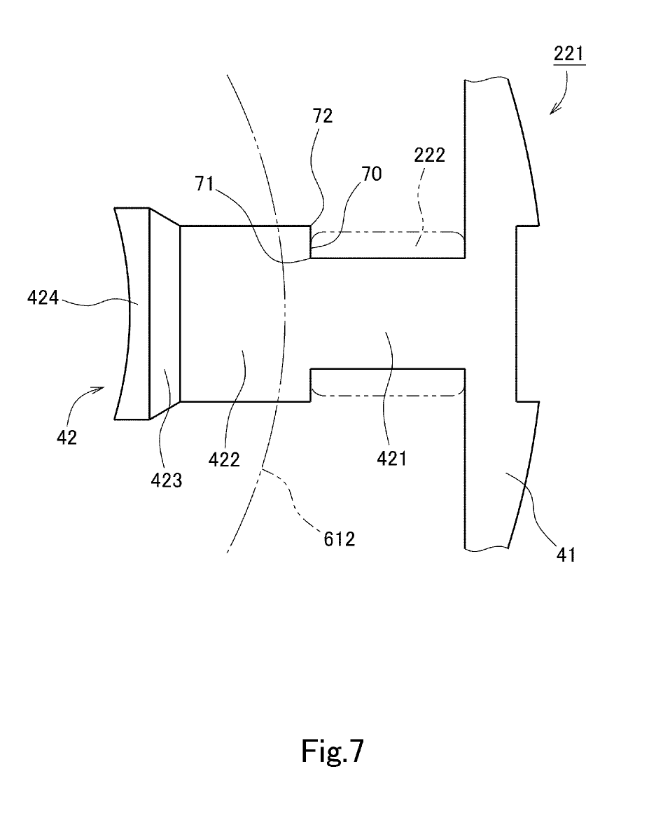

FIG. 6 is a top view of the stator core 221. FIG. 7 is a partial top view of the stator core 221 and shows the vicinity of one of the teeth 42. In FIG. 6 and FIG. 7, the coil 222 and the outer circumference 612 of the hub 31 are depicted by two-dot chain lines. As shown in FIG. 6 and FIG. 7, the circumferential width of the outer core portion 421 of the teeth 42 is preferably smaller than the circumferential widths of the middle core portion 422, the inclined core portion 423, and the end core portion 424. A stepped surface 70 is preferably located between the outer core portion 421 and the middle core portion 422. The stepped surface 70 varies the circumferential width of the teeth 42.

The stepped surface 70 is preferably positioned radially outward from the outer circumference 612 of the hub 31, and positioned radially inward from the coil 222. The stepped surface 70 is opposite to the coil 222 via a gap or in contact with the coil 222 in the radial direction. In the present preferred embodiment, the stepped surface 70 prevents the collapse of the coil 222 on the radially inner side. If the collapse of the coil 222 on the radially inner side is prevented by the stepped surface 70, the conducting wire which defines the coil 222 is prevented from being in contact with the outer circumference 612 of the hub 31. Accordingly, it is possible to locate the coil 222 on the radially outer side of the hub 31. As a result, the axial dimension of the spindle motor 11 can be significantly reduced.

The stepped surface 70 preferably extends in the circumferential direction from the side surface of the teeth 42. That is, the stepped surface 70 is provided without increasing the axial dimension of the teeth 42. Especially, the stator core 221 in the present preferred embodiment is defined by a laminated steel plate member defined by laminating a plurality of magnetic steel plates in the axial direction. For this reason, the stepped surface 70 extending in the circumferential direction can be easily provided.

In the present preferred embodiment, the middle core portion 422, the inclined core portion 423, and the end core portion 424 define an inner core portion. The inner core portion is preferably positioned radially inward from the outer core portion 421. The stepped surface 70 is preferably defined in a radially outer end portion of the inner core portion. In other words, the inner core portion includes a positioning portion including the stepped surface 70 on the radially outer side than the outer circumference of the hub 31 and on the radially inner side than the coil 222. The position of the conducting wire is determined by the positioning portion.

The stepped surface 70 preferably extends in the circumferential direction between a base end portion 71 on the circumferentially inner side of the teeth 42 and a side end portion 72 on the circumferentially outer side of the teeth 42. In the present preferred embodiment, the base end portion 71 is located in the same radial position as the side end portion 72. As shown in FIG. 7, the width of the stepped surface 70 in the circumferential direction is preferably larger than the width of the coil 222 in the circumferential direction. With such a configuration, the contact of the conducting wire which defines the coil 222 with the outer circumference 612 of the hub 31 can be even more significantly reduced and prevented.

In the present preferred embodiment, the widths of the middle core portion 422, the inclined core portion 423, and the end core portion 424 in the circumferential direction are preferably larger than the width of the outer core portion 421 in the circumferential direction, respectively. Accordingly, it is difficult for the magnetic flux generated in the outer core portion 421 to cause magnetic saturation to occur in the middle core portion 422, the inclined core portion 423, and the end core portion 424, respectively. Therefore, the magnetic flux is efficiently generated in a radially inner end portion of each of the teeth 42.

In the present preferred embodiment, the width of the end core portion 424 in the circumferential direction is preferably larger than the width of the middle core portion 422 in the circumferential direction. With such a configuration, the circumferential interval between mutually adjacent end core portions 424 can be decreased. Thus, in the vicinity of the radially inner end portion of each of the teeth 42, the switching of magnetic flux in the circumferential direction is gentle, and the cogging torque can be significantly reduced and prevented.

As shown in FIG. 5, in the present preferred embodiment, the lower portion of the coil 222 is preferably fixed by an adhesive 25. In this way, when at least a portion of the coil 222 is fixed by the adhesive, the collapse of the coil 222 can be further prevented.

The exemplarily preferred embodiments of the present invention have been explained above, but the present invention is not limited to the above-described preferred embodiments.

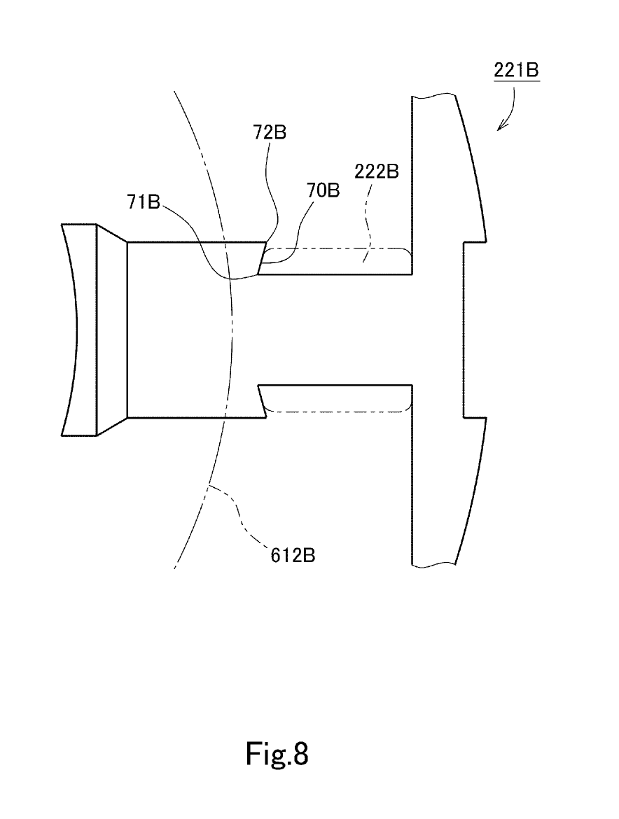

FIG. 8 is a partial top view of a stator core 221B in one modified preferred embodiment of the present invention. In the example shown in FIG. 8, a side end portion 72B of a stepped surface 70B is preferably positioned radially outward from a base end portion 71B of the stepped surface 70B. With such an arrangement, in the vicinity of a radially inner end portion of a coil 222B, the collapse of a coil of a conducting wire is further prevented. Accordingly, the contact between the conducting wiring and an outer circumference 612B of the hub can be reliably prevented.

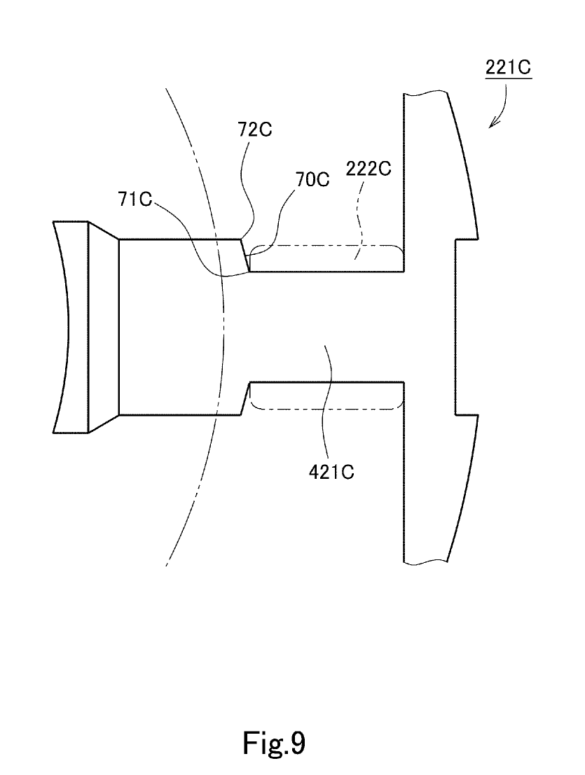

FIG. 9 is a partial top view of a stator core 221C in another modified preferred embodiment of the present invention. In the example shown in FIG. 9, a side end portion 72C of a stepped surface 70C is preferably positioned radially inward from a base end portion 71C of the stepped surface 70C. With such an arrangement, the conducting wire can be easily provided in the vicinity of the radially inner end portion of an outer core portion 421C. Accordingly, the working operation used to form a coil 222C by winding a conducting wire around the outer core portion 421C can be easily performed.

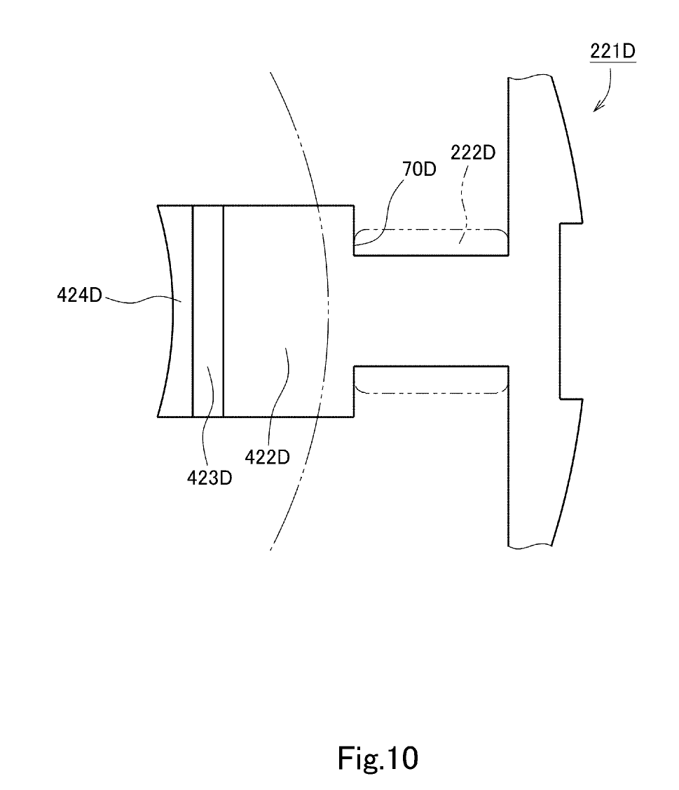

FIG. 10 is a partial top view of a stator core 221D in another modified preferred embodiment of the present invention. In the example shown in FIG. 10, the width of a middle core portion 422D in the circumferential direction, the width of an inclined core portion 423D in the circumferential direction, and the width of an end core portion 424D in the circumferential direction are preferably equal or substantially equal to each other. In this way, a stepped surface 70D can be expanded in the circumferential direction. Accordingly, the collapse of a coil 222D can be further prevented.

As shown in FIG. 7, FIG. 8, and FIG. 9, if the width of the middle core portion in the circumferential direction is preferably made smaller than the width of the end core portion in the circumferential direction, the area in which the upper surface of the middle core portion is opposite to the lower surface of an annular surface portion of the hub can be minimized. As a result, the leakage of magnetic flux from the middle core portion to the annular surface portion can be reduced. Especially in the case where the hub is defined by a magnetic body, the leakage of magnetic flux from the middle core portion to the annular surface portion may easily occur. For this reason, the arrangements shown in FIG. 7, FIG. 8, and FIG. 9 are preferred.

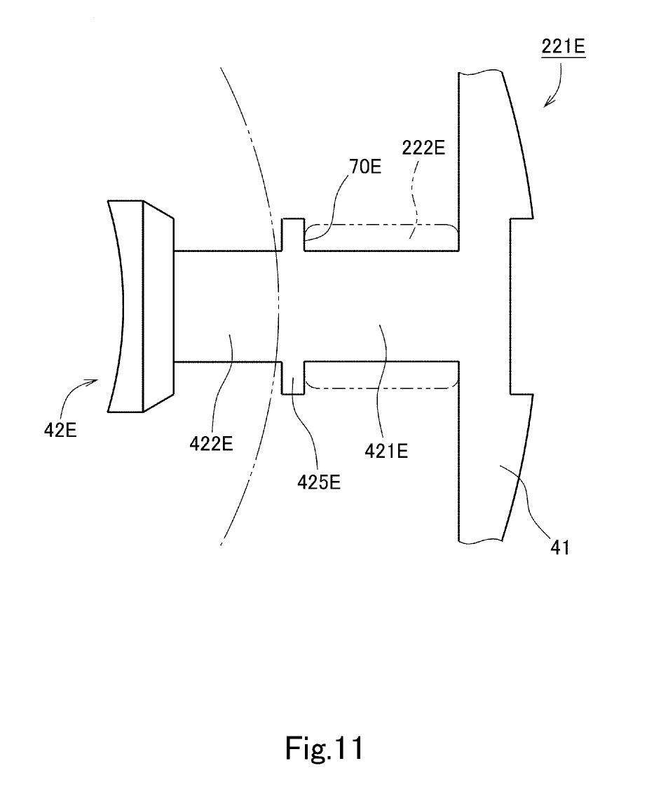

FIG. 11 is a partial top view of a stator core 221E in another modified preferred embodiment of the present invention. In the example shown in FIG. 11, a wall portion 425E is preferably provided between an outer core portion 421E and a middle core portion 422E. The width of the wall portion 425E in the circumferential direction is preferably larger than the width of the outer core portion 421E in the circumferential direction and the width of the middle core portion 422E in the circumferential direction. In addition, the collapse of a coil 222E can be prevented by a stepped surface 70E on the radially outer side of the wall portion 425E.

With such a configuration, the width of the middle core portion 422E in the circumferential direction can be further reduced as compared with the above-described preferred embodiments and the respective modified preferred embodiments. If at least a portion of the middle core portion 422E is preferably arranged so as to overlap the disk supporting portion of the hub in the plan view, the area in which the upper surface of the teeth 42E is opposite to the lower surface of the disk supporting portion can be even more significantly reduced. Accordingly, the leakage of magnetic flux from the teeth 42E to the annular surface portion can be even more significantly reduced and prevented.

It should be noted that if the width of the middle core portion 422E in the circumferential direction is smaller than the width of the outer core portion 421E in the circumferential direction, magnetic saturation may easily occur in the middle core portion 422E. Accordingly, in order to efficiently generate the magnetic flux in the radially inner end portion of the teeth 42E, it is preferred that the width of the middle core portion 42E in the circumferential direction is equal to or larger than the width of the outer core portion 421 in the circumferential direction.

It should be noted that the detailed shapes of the respective members may be different from those shown in the respective figures of the present application.

Various preferred embodiments of the present invention can be applied to a spindle motor and a disk drive apparatus, for example.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A spindle motor comprising:
a stationary portion; and
a rotating portion supported rotatably with respect to the stationary portion and centered on a center axis extending vertically; wherein
the stationary portion includes:
a base portion expanding in a direction orthogonal or substantially orthogonal to the center axis extending vertically;
a ring-shaped core back arranged on a side of an upper surface of the base portion;
a plurality of teeth protruding radially inwards from the core back; and
a coil attached to the teeth;
the rotating portion includes:
a magnet radially opposite to a radially inner end surface of the teeth; and
a hub arranged to hold the magnet;
the teeth include:
an outer core portion, arranged radially outward from an outer circumference of the hub, on which a conducting wire defining the coil is wound; and
an inner core portion arranged radially inward from the outer core portion;
the inner core portion includes a positioning portion which is positioned radially outward from the outer circumference of the hub, and arranged radially inward from the coil; and
a width of the positioning portion in a circumferential direction is larger than a width of the outer core portion in the circumferential direction.

2. A spindle motor according to claim 1, wherein the hub includes a disk supporting portion including a supporting surface which is in contact with a lower surface of a disk and the outer circumference of the hub, and the inner core portion includes a middle core portion radially extending between the disk supporting portion and the base portion at a location radially inward from the outer core portion.

3. A spindle motor according to claim 2, wherein the inner core portion further includes an end core portion arranged radially inward from the middle core portion, and a width of the end core portion in the circumferential direction is larger than a width of the middle core portion in the circumferential direction.

4. A spindle motor according to claim 2, wherein a width of the middle core portion in the circumferential direction is equal to or larger than a width of the outer core portion in the circumferential direction.

5. A spindle motor according to claim 2, wherein the inner core portion further includes an end core portion arranged radially inward from the middle core portion, and a width of the end core portion in the circumferential direction is larger than a width of the middle core portion in the circumferential direction.

6. A spindle motor according to claim 5, wherein an upper end portion of the end core portion is located above the middle core portion, and the inner core portion further includes an inclined core portion arranged to connect the end core portion and the middle core portion.

7. A spindle motor according to claim 5, wherein the disk supporting portion includes an inclined lower surface extending along an upper surface of the inclined core portion.

8. A spindle motor according to claim 1, wherein
the hub includes a disk supporting portion including a supporting surface which is in contact with a lower surface of a disk and the outer circumference;
the inner core portion includes:
a wall portion arranged radially inward from the outer core portion; and
a middle core portion arranged radially inward from the wall portion;
a width of the wall portion in a circumferential direction is larger than a width of the outer core portion and the middle core portion in the circumferential direction; and
at least a portion of the middle core portion overlaps the disk supporting portion in a plan view.

9. A spindle motor according to claim 8, wherein the width of the middle core portion in the circumferential direction is equal to or larger than the width of the outer core portion in the circumferential direction.

10. A spindle motor according to claim 8, wherein the inner core portion further includes an end core portion arranged radially inward from the middle core portion, and a width of the end core portion in the circumferential direction is larger than the width of the middle core portion in the circumferential direction.

11. A spindle motor according to claim 10, wherein an upper end portion of the end core portion is located above the middle core portion, and the inner core portion further includes an inclined core portion arranged to connect the end core portion and the middle core portion.

12. A spindle motor according to claim 10, wherein the disk supporting portion includes an inclined lower surface extending along an upper surface of the inclined core portion.

13. A spindle motor according to claim 8, wherein a width of the middle core portion in a circumferential direction is equal to or larger than a width of the outer core portion in the circumferential direction.

14. A spindle motor according to claim 1, wherein a width of the positioning portion in the circumferential direction is larger than a width of the coil in the circumferential direction.

15. A spindle motor according to claim 1, wherein a radially outer surface of the inner core portion extends substantially in the circumferential direction between a base end portion of the teeth on a circumferentially inner side and a side end portion of the teeth on a circumferentially outer side, and the side end portion is positioned radially outward from the base end portion.

16. A spindle motor according to claim 1, wherein a radially outer surface of the inner core portion expands substantially in the circumferential direction between a base end portion of the teeth on a circumferentially inner side and a side end portion of the teeth on a circumferentially outer side, and the side end portion is arranged radially inward from the base end portion.

17. A spindle motor according to claim 1, wherein the core back and the teeth are defined by a laminated steel member in which magnetic steel plates are laminated on each other in an axial direction.

18. A spindle motor according to claim 1, wherein a lower end portion of the coil is positioned below an upper surface of the base portion.

19. A spindle motor according to claim 1, wherein at least a portion of the coil is fixed by an adhesive.

20. A disk drive apparatus comprising:
a spindle motor recited in claim 1;
an access unit which performs at least one of reading and writing of information from and to a disk supported by the rotating portion of the spindle motor; and
a cover; wherein
the rotating portion and the access unit are accommodated in the interior of a housing defined by the base portion and the cover.
